(19) United States
(12) Patent Application Publication
(10) Pub. No.: US 2024/0314636 A1
(43) Pub. Date: Sep. 19, 2024

(54) MULTI-STREAM QUALITY OF SERVICE ASSURANCE FOR QUIC DATA STREAM OVER A CELLULAR NETWORK

(71) Applicant: Meta Platforms Technologies, LLC, Menlo Park, CA (US)

(72) Inventors: Jimin Liu, Bellevue, WA (US); Curt Wong, Bellevue, WA (US); Yi Lu, Kirkland, WA (US); Jiansong Wang, Lincroft, NJ (US); Ping Wang, Redmond, WA (US); Qi Qu, Redmond, WA (US)

(21) Appl. No.: 18/121,140

(22) Filed: Mar. 14, 2023

(51) Int. Cl. H04W 28/02; H04L 47/6275

(52) U.S. Cl. CPC H04W 28/0289; H04L 47/6275; H04W 28/0236

(57) ABSTRACT

Disclosed herein are systems and method for providing quality of service to data streams transmitted via a single protocol stream. A scheduler of a sender can receive profiles corresponding to streams of data generated by an application of the sender. The scheduler can receive, from a receiver receiving the streams of data, congestion information of some the streams of data. The scheduler can determine, according to the congestion information and the profiles, a priority of a first stream with respect to a second stream of the streams of data, for a single protocol stream. An assembler of the sender can generate a plurality of packets of the single protocol stream using first packets of the first stream and second packets of the second stream in accordance with the priority. The sender can transmit to the receiver, the single protocol stream comprising the plurality of packets.

### FIELD OF DISCLOSURE

The present disclosure is generally related to facilitating wireless communication, including but not limited to reducing interruptions or congestion in communications between wireless communication devices.

### BACKGROUND

User equipment (UE) devices, such as smartphones, laptops, augmented reality (AR) or virtual reality (VR) head wearable displays (HWD), can be used for wireless communication with other network devices or services via cellular, or other wireless networks. Wireless communication can be implemented using a variety of network communication protocols.

UE devices implementing artificial reality, such as a VR, AR or, or a mixed reality (MR), can provide a user with an immersive experience. In one example, a user wearing a HWD or smart glasses can turn the user's head, and an image of a virtual object corresponding to a location of the HWD or smart glasses and a gaze direction of the user can be displayed on the HWD or smart glasses to allow the user to feel as if the user is moving within a space of artificial reality (e.g., a VR space, an AR space, or a MR space).

### SUMMARY

This present disclosure is directed to a solution for providing respective quality of service (QoS) to each of a plurality of data streams of an application of a UE communicated via a cellular network whose QoS framework handles the data streams in a single protocol multi-stream and a single QoS flow. When a single protocol multi-stream (sometimes referred to as a single protocol stream), such as a quick user datagram protocol internet connections (QUIC) data stream, includes multiple dissimilar data streams sharing a single IP 5 tuple and a single QoS flow, latency issues and data disruptions can occur to some of these data streams. The present solution addresses this issue by providing, on a sender device, a scheduler to prioritize and assemble the single protocol multi-stream packets from multiple data streams according to QoS profiles of each of the data streams using congestion feedback information from the receiver device to balance the amount of data packets from each of the data streams within the QUIC stream. The solution can multiplex the data into the single protocol multi-stream packets based on QoS profiles received from the sender-side scheduler. The QoS profiles can be used to instruct the packet assembler as to the desired priority and/or ratio of data packets from each of the individual streams to be within the multi-stream so as to maintain a sufficient distribution of the data packets from each of the data streams, preventing excessive bandwidth consumption by any of the streams within the multi-stream and reducing the latency and delays.

In some aspects, the present disclosure relates to a method. The method can include receiving, by a scheduler of a wireless sender device, a plurality of profiles corresponding to a plurality of streams of data generated by an application of the wireless sender device. The method can include receiving, by the scheduler from a wireless receiver device receiving the plurality of streams of data, information on congestion of at least some the plurality of streams of data. The method can include determining, by the scheduler according to the information on congestion and the plurality of profiles, a priority of a first stream of the plurality of streams of data with respect to a second stream of the plurality of streams of data, for a single protocol stream. The method can include generating, by an assembler of the wireless sender device, a plurality of packets of the single protocol stream using first packets of the first stream and second packets of the second stream in accordance with the determined priority. The method can include transmitting, by the wireless sender device to the wireless receiver device, the single protocol stream comprising the plurality of packets.

The method can include receiving, by the scheduler from the wireless receiver device, the information on congestion indicative of a latency of the first stream or the second stream received via the single protocol stream at the wireless receiver device. The method can include generating, by the scheduler according to the latency, the instruction to prioritize a packet of the first stream over a packet of the second stream.

The method can include receiving, by the scheduler from the wireless receiver device, the information on congestion indicative of a bandwidth of the first stream or the second stream received via the single protocol stream at the wireless receiver device. The method can include generating, by the scheduler according to the bandwidth, the instruction to prioritize a packet of the first stream over a packet of the second stream. Transmitting the single protocol stream can include transmitting, by the wireless sender device, a quick user datagram protocol internet connections (QUIC) stream.

The method can include receiving, by the scheduler from the application, a first profile of the plurality of profiles corresponding to the first stream and a second profile of the plurality of profiles corresponding to the second stream. The first profile can indicate at least one of a first data rate, a first time budget, a first packet size, a first packet loss data or a first packet prioritization data of the first stream. The second profile can indicate at least one of a second data rate, a second time budget, a second packet size, a second packet loss data or a second packet prioritization data of the second stream.

The method can include generating, by the scheduler, the instruction to prioritize the first stream over the second stream according to the first profile and the second profile. The method can include receiving, by the assembler from the scheduler, the instruction. The method can include providing, by the assembler to a packet queue of the wireless sender device according to the instruction, the single protocol stream comprising the plurality of packets.

The method can include determining, by the scheduler using the plurality of profiles, a first data rate and a first time budget for the first stream and a second data rate and a second time budget for the second stream. The method can include generating, by the scheduler, the instruction according to the first data rate, the first time budget, the second data rate and the second time budget.

The method can include determining, by the wireless sender device according to the information on congestion, a codec rate data for one of the first stream or the second stream. The method can include updating, by the application, the codec rate for the first stream or the second stream. The method can include determining, by the wireless sender device according to the information on congestion, a supported rate of video frames of the first stream or the second stream. The method can include dropping, by the application according to the supported rate of the video frames, a video frame of the first stream or the second stream.

In some aspects, the present disclosure relates to a wireless sender device comprising at least one processor. The at least one processor can be configured to receive a plurality of profiles corresponding to a plurality of streams of data generated by an application of the wireless sender device. The at least one processor can be configured to receive, from a wireless receiver device receiving the plurality of streams of data, information on congestion of at least some the plurality of streams of data. The at least one processor can be configured to determine, according to the information on congestion and the plurality of profiles, a priority of a first stream of the plurality of streams of data with respect to a second stream of the plurality of streams of data, for a single protocol stream. The at least one processor can be configured to generate a plurality of packets of the single protocol stream using first packets of the first stream and second packets of the second stream in accordance with the determined priority. The at least one processor can be configured to transmit, to the wireless receiver device, the single protocol stream comprising the plurality of packets.

The at least one processor can be configured to receive, from the wireless receiver device, the information on congestion indicative of a latency of the first stream or the second stream received via the single protocol stream at the wireless receiver device. The at least one processor can be configured to generate, according to the latency, the instruction to prioritize a packet of the first stream over a packet of the second stream.

The at least one processor can be configured to receive, from the wireless receiver device, the information on congestion indicative of a bandwidth of the first stream or the second stream received via the single protocol stream at the wireless receiver device. The at least one processor can be configured to generate, according to the bandwidth, the instruction to prioritize a packet of the first stream over a packet of the second stream. The single protocol stream can include a quick user datagram protocol internet connections (QUIC) stream.

The at least one processor can be configured to receive, from the application, a first profile of the plurality of profiles corresponding to the first stream and a second profile of the plurality of profiles corresponding to the second stream. The first profile can indicate at least one of a first data rate, a first time budget, a first packet size, a first packet loss data or a first packet prioritization data of the first stream. The second profile can indicate at least one of a second data rate, a second time budget, a second packet size, a second packet loss data or a second packet prioritization data of the second stream. The at least one processor can be configured to generate the instruction to prioritize the first stream over the second stream according to the first profile and the second profile.

The at least one processor can be configured to receive, from the scheduler, the instruction. The at least one processor can be configured to provide, to a packet queue of the wireless sender device according to the instruction, the single protocol stream comprising the plurality of packets. The at least one processor can be configured to determine, using the plurality of profiles, a first data rate and a first time budget for the first stream and a second data rate and a second time budget for the second stream. The at least one processor can be configured to generate the instruction according to the first data rate, the first time budget, the second data rate and the second time budget.

The at least one processor can be configured to determine, according to the information on congestion, a codec rate data for one of the first stream or the second stream. The at least one processor can be configured to update, by the application of the wireless sender device, the codec rate for the first stream or the second stream. The at least one processor can be configured to determine, according to the information on congestion, a supported rate of video frames of the first stream or the second stream. The at least one processor can be configured to drop, by the application of the wireless sender device according to the supported rate of the video frames, a video frame of the first stream or the second stream.

In some aspects, the present disclosure relates to a non-transitory computer readable medium storing program instructions. The instructions can be for causing at least one processor of a device to receive a plurality of profiles corresponding to a plurality of streams of data generated by an application of the wireless sender device. The instructions can be for causing at least one processor of a device to receive, from a wireless receiver device receiving the plurality of streams of data, information on congestion of at least some the plurality of streams of data. The instructions can be for causing at least one processor of a device to determine, according to the information on congestion and the plurality of profiles, a priority of a first stream of the plurality of streams of data with respect to a second stream of the plurality of streams of data, for a single protocol stream. The instructions can be for causing at least one processor of a device to generate a plurality of packets of the single protocol stream using first packets of the first stream and second packets of the second stream in accordance with the determined priority. The instructions can be for causing at least one processor of a device to transmit, to the wireless receiver device, the single protocol stream comprising the plurality of packets.

The instructions can be for causing at least one processor of a device to receive, from the wireless receiver device, the information on congestion indicative of one of a latency of the first stream or the second stream or a bandwidth of the first stream or the second stream. The latency or the bandwidth can be received via the single protocol stream comprising a quick user datagram protocol internet connections (QUIC) stream at the wireless receiver device. The instructions can be for causing at least one processor of a device to generate, according to the latency or the bandwidth, the instruction to prioritize a packet of the first stream over a packet of the second stream for the (QUIC) stream.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a block diagram of a system for providing feedback based quality of service differentiation for/between multiple data streams transmitted via a single protocol multi-stream data to a receiver device.

FIG. 5 is an example of a wireless sender device providing feedback based quality of service differentiation for/between multiple data streams transmitted via a single protocol multi-stream data to a receiver device.

FIG. 6 is a flow diagram of an example process of providing feedback based quality of service differentiation for/between multiple data streams transmitted via a single protocol multi-stream data to a receiver device.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

This disclosure is directed to systems and methods for reducing latency in quick user datagram protocol (UDP) internet connections (QUIC) data streams transmitted over cellular networks. QUIC data streams can be communicated from a UE over a 5G system whose configuration can include a quality of service (QOS) framework transmitting multiple encrypted data streams generated by an application of the UE via a single QUIC stream processed by a single QoS flow. The single QoS flow of data from a VR/AR QUIC-based application can include data streams (e.g., a video stream, an audio stream, a control stream or a signaling stream) each sharing a single IP 5 tuple within the QUIC multi-stream. Since data streams within the QUIC stream can be dissimilar and can utilize different amounts of bandwidth and can tolerate different levels of latency, when a UE device experiences a drop in the available bandwidth, it can be challenging to control latency of the data streams within the QUIC data stream, causing data delays and interruptions.

For example, when a UE steps into a zone of a reduced signal coverage, different data streams within the single QUIC stream from the VR/AR application can be transmitted at rates that are insufficient to maintain uninterrupted user service. This problem can be further exacerbated when some of the data streams within the QUIC stream, such as for example a video stream, consume a disproportionately large amount of the available bandwidth within the QUIC stream, leaving an insufficient amount of bandwidth for the remaining streams, such as for example the control or the communication streams. In such instances, the user can experience delays or intermittent service, adversely affecting the user experience.

The present solution addresses this issue by providing, on a sender device, a multi-stream scheduler to prioritize and assemble QUIC packets from packets of multiple data streams, according to QoS profiles for each of the data streams, into a QUIC stream. Based on congestion feedback from the receiver, the present solution can utilize a packet assembler of the sender to balance the amount of data packets from each of the data streams within the QUIC stream, such that the data is multiplexed into the QUIC stream data packets based on QoS profiles received from the sender-side scheduler. The QoS profiles can be used to instruct the packet assembler as to the ratio of data for each of the streams within the QUIC stream, so as to maintain a sufficient distribution of the data packets from each of the data streams, preventing excessive bandwidth consumption by some of the streams within the QUIC stream at the expense of others, and reducing the delays and improving the user experience.

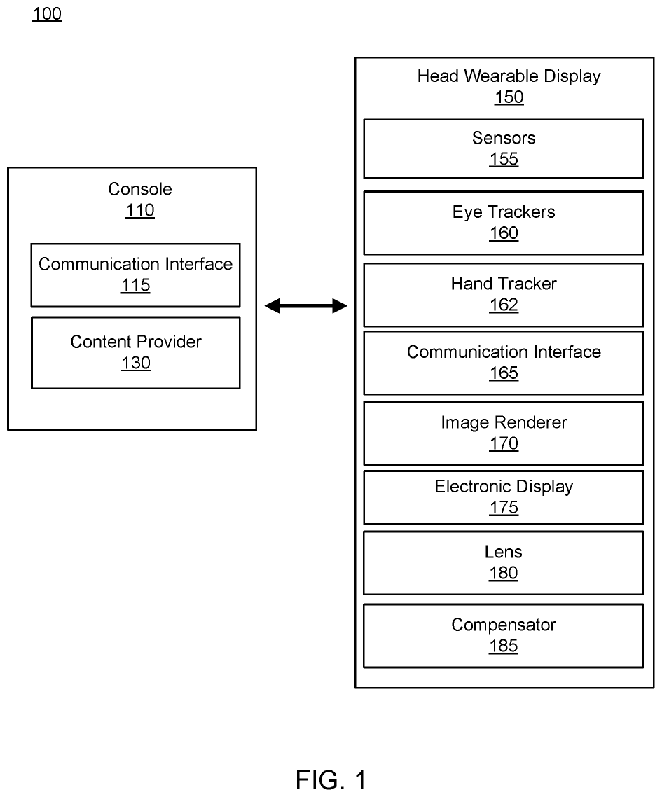

FIG. 1 is a block diagram of an example artificial reality system environment 100. In some embodiments, the artificial reality system environment 100 includes a HWD 150 worn by a user, and a console 110 providing content of artificial reality to the HWD 150. The HWD and/or console may be UEs in a cellular network for instance. The HWD 150 may be referred to as, include, or be part of a head mounted display (HMD), head mounted device (HMD), head wearable device (HWD), head worn display (HWD) or head worn device (HWD). The HWD 150 may detect its location and/or orientation of the HWD 150 as well as a shape, location, and/or an orientation of the body/hand/face of the user, and provide the detected location/or orientation of the HWD 150 and/or tracking information indicating the shape, location, and/or orientation of the body/hand/face to the console 110. The console 110 may generate image data indicating an image of the artificial reality according to the detected location and/or orientation of the HDM 150, the detected shape, location and/or orientation of the body/hand/face of the user, and/or a user input for the artificial reality, and transmit the image data to the HWD 150 for presentation. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some embodiments, the console 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. For example, audio can be presented via an external device (e.g., speakers and/or headphones) that receives audio information from the HWD 150, the console 110, or both, and presents audio based on the audio information. The HWD 150 can include sensors 155, eye trackers 160, a hand tracker 162, a communication interface 165, an image renderer 170, an electronic display 175, a lens 180, and a compensator 185. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detect a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees From a reference direction, in response to detecting that the HWD 150 has rotated 20 degrees, the sensors 155 may determine that the HWD 150 now faces or is oriented in a direction 45 degrees From the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination of them may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gate direction of the user. Assuming for an example that the HWD 150 is oriented at a direction 30 degrees From a reference direction, and the relative gaze direction of the HWD 150 is −10 degrees (or 350 degrees) with respect to the HWD 150, the eye trackers 160 may determine that the gaze direction of the user is 20 degrees From the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and an orientation of the hand. The hand tracker 162 may generate hand tracking measurements indicating the detected shape, location and orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link. Examples of the wireless link can include a cellular communication link, a near field communication link, Wi-Fi, Bluetooth, 60 GHz wireless link, or any communication wireless communication link. Through the communication link, the communication interface 165 may transmit to the console 110 data indicating the determined location and/or orientation of the HWD 150, the determined gaze direction of the user, and/or hand tracking measurement. Moreover, through the communication link, the communication interface 165 may receive from the console 110 image data indicating or corresponding to an image to be rendered and additional data associated with the image.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, image data describing an image of artificial reality to be rendered and additional data associated with the image, and render the image through the electronic display 175. In some embodiments, the image data from the console 110 may be encoded, and the image renderer 170 may decode the image data to render the image. In some embodiments, the image renderer 170 receives, from the console 110 in additional data, object information indicating virtual objects in the artificial reality space and depth information indicating depth (or distances from the HWD 150) of the virtual objects. In one aspect, according to the image of the artificial reality, object information, depth information from the console 110, and/or updated sensor measurements from the sensors 155, the image renderer 170 may perform shading, reprojection, and/or blending to update the image of the artificial reality to correspond to the updated location and/or orientation of the HWD 150. Assuming that a user rotated his head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality. In some embodiments, the image renderer 170 receives hand model data indicating a shape, a location and an orientation of a hand model corresponding to the hand of the user, and overlay the hand model on the image of the artificial reality. Such hand model may be presented as a visual feedback to allow a user to provide various interactions within the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 150 in a physical space into a virtual space (or simultaneous localization and mapping (SLAM) data), eye tracking data, motion vector information, depth information, edge information, object information, etc. The console 110 may provide the image data and the additional data to the HWD 150 for presentation of the artificial reality. In other embodiments, the console 110 includes more, fewer, or different components than shown in FIG. 1. In some embodiments, the console 110 is integrated as part of the HWD 150.

In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., wireless link). Through the communication link, the communication interface 115 may receive from the HWD 150 data indicating the determined location and/or orientation of the HWD 150, the determined gaze direction of the user, and the hand tracking measurement. Moreover, through the communication link, the communication interface 115 may transmit to the HWD 150 image data describing an image to be rendered and additional data associated with the image of the artificial reality.

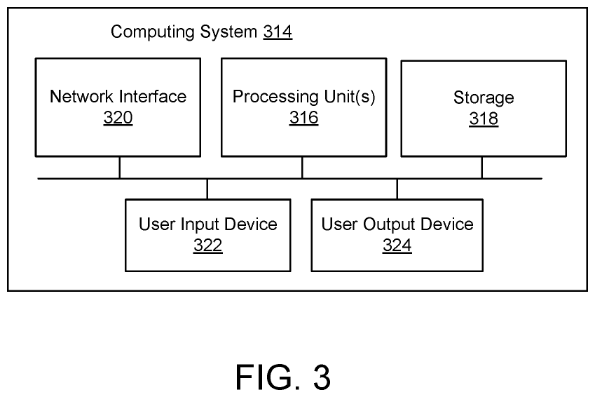

The content provider 130 can include or correspond to a component that generates content to be rendered according to the location and/or orientation of the HWD 150. In some embodiments, the content provider 130 may incorporate the gaze direction of the user of the HWD 150, and a user interaction in the artificial reality based on hand tracking measurements to generate the content to be rendered. In one aspect, the content provider 130 determines a view of the artificial reality according to the location and/or orientation of the HWD 150. For example, the content provider 130 maps the location of the HWD 150 in a physical space to a location within an artificial reality space, and determines a view of the artificial reality space along a direction corresponding to the mapped orientation from the mapped location in the artificial reality space. The content provider 130 may generate image data describing an image of the determined view of the artificial reality space, and transmit the image data to the HWD 150 through the communication interface 115. The content provider 130 may also generate a hand model corresponding to a hand of a user of the HWD 150 according to the hand tracking measurement, and generate hand model data indicating a shape, a location, and an orientation of the hand model in the artificial reality space. In some embodiments, the content provider 130 may generate additional data including motion vector information, depth information, edge information, object information, hand model data, etc., associated with the image, and transmit the additional data together with the image data to the HWD 150 through the communication interface 115. The content provider 130 may encode the image data describing the image, and can transmit the encoded data to the HWD 150. In some embodiments, the content provider 130 generates and provides the image data to the HWD 150 periodically (e.g., every 11 ms). In one aspect, the communication interface 115 can adaptively transmit the additional data to the HWD 150 as described below with respect to FIGS. 3 through 6.

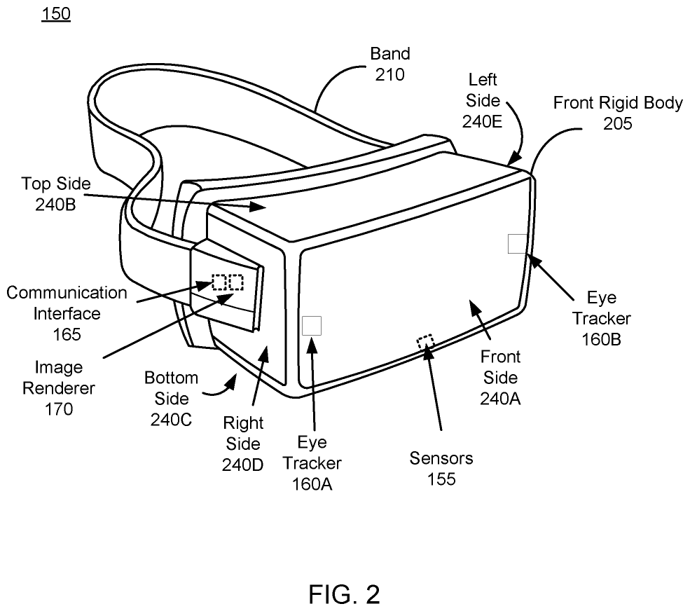

FIG. 2 is a diagram of a HWD 150, in accordance with an example embodiment. In some embodiments, the HWD 150 includes a front rigid body 205 and a head band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the communication interface 165, the image renderer 170, and the sensors 155 are located within the front rigid body 205, and may not visible to the user. In other embodiments, the HWD 150 has a different configuration than shown in FIG. 2. For example, the communication interface 165, the image renderer 170, the eye trackers 160A, 160B, and/or the sensors 155 may be in different locations than shown in FIG. 2.

Various operations described herein can be implemented on computer systems. FIG. 3 shows a block diagram of an example computing system 314 that can be used to implement the present disclosure. In some embodiments, a wireless communication device or a user equipment (e.g., a console 110 or a HWD 150) can be implemented by a computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience, or to implement wireless communication, such as communication over a cellular network (e.g., 4G or 5G network). In some embodiments, the computing system 314 can include conventional computer components such as processors 316, storage device 318, network interface 320, user input device 322, and user output device 324.

Computing system 314 can include one or more processing units 316 (e.g., digital signal processors, microprocessors, system on a chip integrated circuits, media processors, graphics processors, microcontrollers and others). Processing units 316 can include or be coupled with memory, such as read only memory (ROM), random access memory (RAM), static RAM (SRAM), dynamic RAM (DRAM) or flash memory. Memory can store instructions or commands for operating the processors 316.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), memory (e.g . . . , read only memory (ROM), random access memory (RAM), static RAM (SRAM), dynamic RAM (DRAM), flash memory) and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

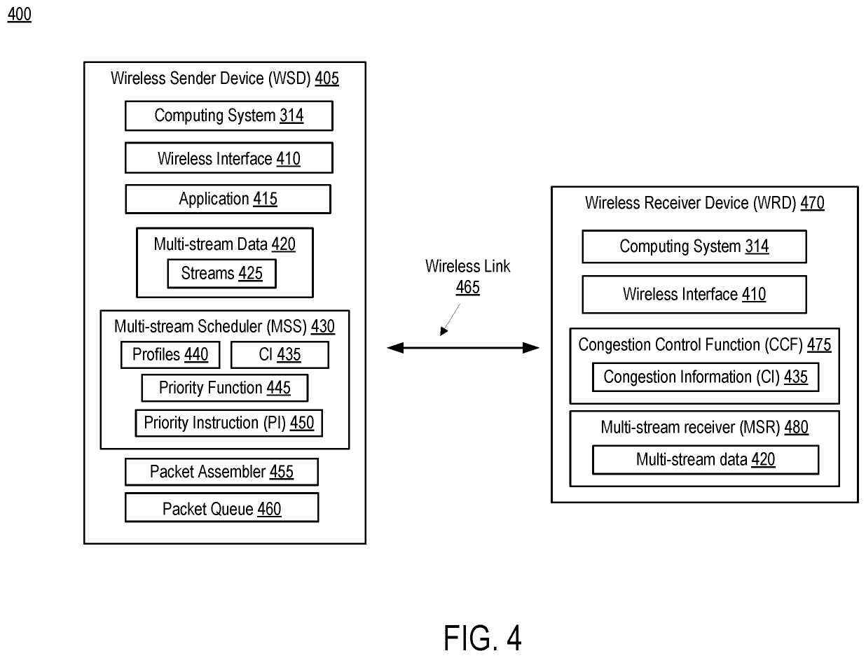

FIG. 4 illustrates an example of a system 400 for providing a quality of service for data of streams transmitted via a single protocol multi-stream to a receiver device using QoS profiles of the streams and the congestion information received from the receiver device. System 400 can include a wireless sender device (WSD) 405 communicating with a wireless receiver device (WRD) 470, via a wireless link 465. A WSD 405 can include one or more computing systems 314, wireless interfaces 410, applications 415, multi-stream data 420 comprising streams 425, packet assemblers 455, packets queues 460 and/or multi-stream schedulers (MSSs) 430. The MSS 430 can include one or more profiles 440, congestion information (CI) 435, priority functions 445 and/or priority instructions 450. Across the wireless link 465, the WSD 470 can include one or more computing systems 314, wireless interfaces 410 and/or congestion control functions (CCFs) 475 comprising one or more CIs 435. WRD 470 can also include a multi-stream receiver (MSR) 480 receiving the multi-stream data 420.

At a high level, the system 400 can include a WSD 405 using a computing system 314 to execute an application 415 generating streams 425 of data. Each of the streams 425 can have a corresponding profile 440 providing data transmission information (e.g., bandwidth, inter-packet arrival rate, packet size, average data rate, minimum or maximum data rates or data priority information) corresponding to each of the streams 425. An MSS 430 can utilize profiles 440 and the CI 435 (e.g., updated latency or bandwidth measurements or indications for the streams 425) received from the WRD 470 to generate priority instructions 450 via a priority function 445. The priority function 445 can prioritize some streams 425 over other, according to the CI 435 and the profiles 440 and allow the packet assembler 455 to generate network packets of the single protocol multi-stream data 420 (e.g., a QUIC multi-stream) to include various amounts or ratios of packets from various streams 425. Single protocol stream packets (e.g., QUIC packets) can be provided to or stored in a packet queue 460, from which they can be transmitted, via the wireless link 465, to the MSR 480 receiving and processing the multi-stream data 420. Using the received multi-stream data 420, the congestion control function 475 can determine new CI 435 and send the CI 435 to the WSD 405 to allow the MSS 430 to make any future adjustments to the rates for each of the streams 425 to be transmitted via the single protocol stream (e.g., multi-stream data 420).

In some cellular networks, such as 5G systems, UL and DL traffic classification can be based on PDR (Packet Detection Rules) for DL communication, while QoS rules (traffic filters) can be utilized for UL communication. Sometimes, single protocol multi-stream data 420 (e.g., a QUIC stream) can be used for UL transmissions. In such instances, a single protocol multi-stream traffic can use 5 tuples to classify the UL traffic. The 5 tuple can include a source internet protocol (IP) address, a destination IP address, a source port, a destination port, a protocol identifier (ID), which can be the same for all data transmitted via the single protocol stream (e.g., multi-stream data 420).

However, as different applications 415 may generate different data streams 425 using different tuples to denote different classification of their individual streams 425 for different QoS treatment by 5GS, it can be difficult to recognize particular streams 425 within such single protocol streams (e.g., single 5 tuple multi-stream data 420). As a cellular network (e.g., 5G network) carries multiple stream 425 within a single QoS flow (because each of the data packets share the same IP 5 tuple), it can be challenging to differentiate between different streams 425, especially when all packets of the multi-stream data 420 (e.g., QUIC packets) are encrypted. Since some streams 425 (e.g., a video stream in a QUIC multi-stream) can be dominant for some applications 415 (e.g., a VR/AR application) due to the high bandwidth and stringent latency requirements of the stream 425, data packets of such a dominant stream 425 can consume more available bandwidth than other streams 425. This can adversely affect the transmission of other time-sensitive and high priority streams 425 (e.g., audio, signaling or control streams 425). For example, when the available bandwidth drops down due to user mobility, lower encoding rate can occur and the dominant stream 425 (e.g., video in AR/VR applications 415) can block all other streams 425 until the video buffer is nearly empty.

In such an example, the present solution can allow the single protocol multi-stream data 420 layer (e.g., the QUIC layer) to determine the maximum available bandwidth at the transport layer based on existing congestion control or L4S congestion control mechanisms. The solution can allow the application 415 to initiate different identifiers for different streams 425 of the application 415. Application 415 can then send the profile 440 (e.g., QoS profile) for each stream 425 to the QUIC layer and the multi-stream scheduler 430 can perform packet scheduling and prioritization (e.g., at the QUIC layer) to transport layer (e.g., UDP) based on the profiles 440 received for each stream 425 and the congestion information 435 received from the WRD 470.

Wireless receiver device (WRD) 470 can include any network device or a service capable of communication with the WSD 405 via a wireless communication link 465 (also referred to as the “wireless link 465”). WRD 470 can include a base station of a cellular network or any server or application of a core cellular network, such as any application or a service of a 4G core system or a 5G core system. For example, a WRD 470 can include a user plane function (UPF) of a 5G core cellular system, a network exposure functions (NEF), an access and mobility management function (AMF), session management function (SMF), policy control functions (PCF) or any other combination of devices, services, applications or functions for a cellular network.

The wireless link 465 can be a cellular communication link, such as a communication link for communicating via a 3G, 4G, 5G, 6G or other cellular communication protocols. Wireless link 465 can support, include, employ or otherwise use an orthogonal frequency division multiple (OFDM) access (also referred to as the OFDMA) and communications can be organized using OFDM slots. A WSD 405 can be oriented, positioned or located in any orientation, position or within any geographical area or a boundary with respect to the WRD 470, and/or worn or held in any way/position relative to a user's body (and such information can be part of a UE's characteristics). WSD 405 can communicate with or via the WRD 470 that can include a base station 470, and with other UEs (e.g., WSDs 405). A plurality of WSDs 405 can be in communication with a plurality of WRDs 470, forming a radio access network (RAN).

Wireless sender device (WSD) 405, also referred to as the UE 405, can include any electronic device capable of wireless communication. WSD 405 can include a user device, such as a mobile phone, a smart phone, a personal digital assistant (PDA), tablet, laptop computer, wearable computing device (e.g., head mounted display, smart glasses, smart watch), or an AR/VR device. WSD 405 can communicate with the WRD 470 through any number of wireless links 465, utilizing any wireless communication configurations or protocols (e.g., 3G, 4G, 5G, 6G or other cellular communication). WSD 405 and WRD 470 can exchange audio data, video data, image data, text, commands, instructions, etc. In some embodiments, communication or transmission of data by the WSD 405 to the WRD 470 may be referred to as an uplink communication. In some embodiments, communication or reception of data to the WSD 405 from the WRD 470 may be referred to as a downlink communication.

WRD 470 can be or include an evolved node B (eNB), a gNodeB, a femto station, or a pico station. WRD 470 can be communicatively coupled to another WRD 470 or other communication devices through a wireless communication link (e.g., another wireless link 465) and/or a wired communication link. WRD 470 can receive data (or a RF signal) in an uplink communication from a WSD 405. Additionally or alternatively, WRD 470 can provide data to another WSD 405, another WRD 470, or any other communication device. Hence, WRD 470 can allow communication among WSDs 405 associated with the WRD 470 (e.g., a base station of a cellular network), or with other WSDs 405 associated with different WRDs 470 (e.g., different base stations). WRD 470 can include a multi-stream receiver 480 for receiving multi-stream data 420 comprising data packets or contents of data packets of streams 425. WRD 470 can also include a congestion control function 475 for determining congestion information 435, such as by taking measurements or making determinations corresponding to any congestion information 435 (e.g., latency, bandwidth or similar).

Both the WSD 405 and WRD 470 can include a wireless interface 410, a computing system 314 and one or more antennas 415. Wireless interfaces 410, computing systems 314 and antennas 415 can each be embodied as a combination of hardware and software and can be integrated to provide network communication (e.g., downlink and uplink communication). For example, WSD 405 can include includes more, fewer, or different components than shown in FIG. 4. For example, the WSD 405 can include an electronic display and/or an input device, additional antennas 415 or wireless interfaces 410 than shown in FIG. 2.

Antenna 415 can include a component that receives a radio frequency (RF) signal and/or transmits a RF signal through a wireless medium. The RF signal can be received or transmitted at a frequency between 200 MHz to 100 GHz for example. The RF signal may have packets, symbols, or frames corresponding to data for communication. The antenna 415 can be a dipole antenna, a patch antenna, a ring antenna, an antenna array or any suitable antenna for wireless communication. In one aspect, a single antenna 415 can be utilized for both transmitting a RF signal and receiving a RF signal. In one aspect, different antennas 415 can be utilized for transmitting the RF signal and receiving the RF signal. In one aspect, multiple antennas 415 are utilized to support multiple-in, multiple-out (MIMO) communication.

Wireless interface 410 (included in a UE 405 or base station 470) can include or be embodied as a transceiver for transmitting and receiving RF signals through one or more antennas 415. For example, a wireless interface 410 of the UE 405 can use an antenna 415 of the UE 405 to communicate with an antenna 415 and the wireless interface 410 of the base station 470 through a wireless link 460, and vice versa or another network device (e.g., another UE 405). Wireless interface 410 of a system or a device (e.g., UE 405 or base station 470) can be coupled to one or more antennas 415 and receive the RF signal at the RF frequency received through an antenna 415. Wireless interface 410 can include the circuitry to downconvert the RF signal to a baseband frequency (e.g., 0˜1 GHz). Wireless interface 415 can include the circuitry to provide the downconverted signal to the processor 316 of the computing system 314. Wireless interface 410 can receive a baseband signal for transmission at a baseband frequency from the processor 316, and upconvert the baseband signal to generate a RF signal. Wireless interface 410 can transmit the RF signal through the antenna 415 to the receiving device (e.g., WRD 470, another EU 405 or any other communication device).

Computing system 314 (on the WSD 405 or WRD 470) can include processors 316 for processing data and implementing the functionality of the present solution (e.g., an application 415, a multi-stream scheduler 430, a packet assembler 455 or a packet queue 460). Processors 316 can be embodied as field programmable gate array (FPGA), application specific integrated circuit (ASIC), a logic circuit, etc. Processors 316 can be coupled with or include memory for information storage (e.g., SRAM, DRAM or cache memory) that can store instructions which the processors 316 can obtain and execute. In one aspect, processor 316 can receive downconverted data at the baseband frequency from the wireless interface 410, and decode or process the downconverted data. For example, the processor 316 can generate audio data or image data according to the downconverted data, and present an audio indicated by the audio data and/or an image indicated by the image data to a user of the UE 405. In one aspect, the processor 316 can generate or obtain data for transmission at the baseband frequency, and encode or process the data. For example, processor 316 can encode or process image data or audio data at the baseband frequency, and provide the encoded or processed data to the wireless interface 410 for transmission.

Computing system 314 can include memory devices embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory devices can be embodied as a non-transitory computer readable medium storing instructions executable by the processor 316 to perform various functions of the WSD (e.g., UE) 405 disclosed herein.

Application 415 can include any application executing on, or using, a computing system 314. Application 415 can include any application of a computing device generating, outputting or providing one or more data streams 425. Application 415 can include any application receiving one or more data streams 425 as input. Application 415 can include any application relying on, using, or providing or receiving data via, a quick UDP internet connections (QUIC) transport layer network protocol (e.g., a QUIC-based application). Application 415 can include a video streaming application for streaming video files from the internet or a network, an audio streaming application, a video conferencing application, a voice over IP communication application, an AR/VR application executing on an AR/VR UE, or any application that can utilize multiple streams of data (e.g., multi-stream data 420).

Application 415 can generate or receive any type and form of data streams 415. A stream 425 can include any continuous flow of network or data packets generated, provided, created, received, used or otherwise corresponding to the application 415 can include any data stream. Streams 425 can include network packets of data or information of a particular type. For example, stream 425 can include a video stream for representing or providing data of a video file. Stream 425 can include an audio stream for representing or providing data of an audio file, such as an audio for a video. Stream 425 can include a signaling stream for representing or providing signaling data or information (e.g., feedback information, transmission or status data, connection or session signals, error codes and more). Stream 425 can include a control stream for providing control signals, instructions or commands for data communicated.

Multi-stream data 420 can include a stream of data including, incorporating or corresponding to data, information or network packets of one or more streams 425. Multi-stream data 420 can include a single protocol stream, such as a stream of data of a multiplexed and secure transport protocol, such as a QUIC protocol. Multi-stream data 420 can include network or data packets (e.g., such as packets generated by the packet assembler 455) that can include information, data, payload or contents of any number of streams 425. Multi-stream data 420 can include, for example, a flow or a plurality of network packets, any one of which can include or correspond to data packets of a video stream 425, an audio stream 425, a signaling stream 425, a control stream 425 or any other data stream 425 generated, provided or output from an application 415.

Profiles 440 can include any collection of information pertaining or corresponding to a stream 425. Profile 440 can include a QoS profile of a stream 425. For example, a profile 440 can include QoS classes, rules, instructions, configurations and settings for control, management, processing or prioritizing data or information. Profile 440 can include a tree structure of classes of a data in a data stream 425. Profile 440 can include instructions, settings or configurations for handling, processing or controlling data (e.g., of a stream 425) according to any information or setting, such as a source or destination data, type or format of data or application 415 that generated the data. Profile 440 can include instructions, settings or configurations for handing, processing or controlling data according to congestion information 435, such as a latency, bandwidth or any other feedback information pertaining to the same or a different stream 425 being transmitted from the WSD 405.

Profile 440 can include any information pertaining to a specific stream 425 within a single protocol stream (e.g., QUIC stream), such as inter-packet arrival rate which can identify a time within which a data burst arrives from the WSD 405 to WRD 470 (e.g., 2 ms, 4 ms or 10 ms). Profile 440 can include or identify a packet size (e.g., a video packet size of 1260 bytes), average data rate (e.g., 30 Mbps), minimum data rate (e.g., 100 kbps or any other amount corresponding to a minimum amount of bandwidth to maintain the connection or service quality) or a maximum data rate (e.g., 50 Mbps or any other amount corresponding to a bandwidth ceiling for transmission). Profile 440 can include or identify a relative stream priority (e.g., from lowest to highest, such as 0 to 9) which can be used to prioritize transmission of some packets over others. Profile 440 can include or identify a maximum or minimum allowable packet loss rate (e.g., packets lost per unit of time). Profile 440 can include or identify maximum or minimum allowable packet time budget (e.g., for traffic shaping to indicate how long data can be stored in a buffer before it is considered too stale for transmission). Profile 440 can include or identify packet prioritization data or information.

Congestion information (CI) 435 can include any information or data corresponding to transmission of packets of a stream 425. CI 435 can include any information or data on congestion, latency or delay of a stream 425. CI 435 can include information indicative of latency or bandwidth of a particular stream 425 transmitted via a single protocol multi-stream (e.g., QUIC multi-stream data 420). CI 435 can include, for example, transmission or receipt data rate packets corresponding to a particular stream 425 in a multi-stream data 420 received by the WRD 470. CI 435 can include, for example, transmission or receipt time budget of the packets corresponding to a particular stream 425 in a multi-stream data 420 received by the WRD 470. CI 435 can include packet arrival rate, or inter-packet arrival rate indicating data burst arrivals, or time to receive a data packet, packets size, average data rate, measured data rate, minimum or maximum data rates, packet loss rate or packet loss amount or any other information pertaining to transmission of any data of any stream 425 or multi-stream data 420. CI 435 can include data indicative of quality, speed, efficiency or delays associated with transmission of stream 425 data and can be indicative of relative latency or bandwidth of any stream 425 within a multi-stream data 420.

Multi-stream scheduler (MSS) 430 can include any combination of hardware and software for scheduling transmission of data packets of any streams 425 via any single protocol stream (e.g., a QUIC multi-stream data 420). MSS 430 can include the functionality for generating, creating or providing a data packet of a single protocol multi-stream data 420 (e.g., a QUIC data packet) to include any number of data packets from any number of streams 425. For example, MSS 430 can determine a number of data packets or amount of payload contents from any number of packets of any one or more streams 425 to be included into a data packet of the single protocol multi-stream (e.g., a QUIC data packet). For example, MSS 430 can determine a first amount (e.g., a number) of data packets of a first stream 425 to be included into a new single protocol data packet of a single protocol stream (e.g., a QUIC packets) and a second amount (e.g., a second number) of data packets of a second stream 425 is to be included into the same single protocol data packet. MSS 430 can generate or provide a data packet of a single protocol multi-stream comprising multiple data packets of a first stream 425A and only a single data packet of a second stream 425 for example.

MSS 430 can create single protocol data packets using any number of data packets or any number of contents (e.g., payloads) of any data packets of any streams 425, in accordance with the priority instructions 455 or profiles 440. For example, a MSS 430 can schedule transmission of data packets from various streams 425 in their order of priority determined by the priority function 445. MSS 430 can interface with, utilize or include a priority function 445 to prioritize transmission of data packets of different streams 425 generated by application 415. MSS 430 can interface with, utilize or include packet assembler 455 to assemble data packets that include data packets (or contents of data packets) of streams 425. MSS 430 can schedule transmission of data packets using profiles 440 or any information or data indicated by profiles 440.

Priority function 445 can include any combination of hardware and software for determining a priority of data packets from various streams 425. Priority function 445 can include the functionality to determine a first priority for a first data packet of a first stream 425 to be higher than a second priority of a second data packet of a second stream 425. Priority function 445 can determine priority of data packets of various streams 425 for the purposes of including a particular ratio or amount of data packets from particular streams 425 into a data packet of a single protocol multi-stream data 420 (e.g., QUIC data packet). Priority function 445 can determine priority of a data packet from a first stream 425 over another data packet of a second stream 425 based on, using, or according to congestion information 435 received from a WRD 470. Priority function 445 can determine priority of a data packet from a first stream 425 over another data packet of a second stream 425 based on, using, or according to profiles 440 corresponding to the first stream 425 and the second stream 425. For example, each stream 425 can include its own profile 440, which the priority function 445 can use for determining priority for the data packets of each of the streams 425.

Priority function 445 can determine, generate and provide priority instructions 450 for prioritizing data packets from each of the streams. Priority instruction 450 can be used/sent to instruct a MSS 430 to prioritize one stream 425 (e.g., 425A) over another stream 425 (e.g., 425B) or to prioritize one or more data packets of one stream 425A over one or more data packets of another stream 425B. For example, upon determining that a first stream 425A has a higher priority than a second stream 425B, priority function 445 can generate or provide a priority instruction 450 to a MSS 430 indicating the priorities of either one, or both, of the first stream 425A and the second stream 425B. The MSS 430 can then use the priority instruction 450 to generate a data packet of the multi-stream protocol (e.g., QUIC data packet) in accordance with the priority of each of the streams 425. For example, priority instruction 450 can indicate to the MSS 430 that a first stream 425A has a priority of 6 of 10, while a second stream 425B has a priority of 3 of 10. In response to the priority instruction 450 indicating that the stream 425A has a twice larger priority than stream 425B, the MSS 430 can determine that a data packet of the multi-stream data 420 should include two data packets from the first stream 425A and a single data packet from the second stream 425B.

Packet assembler 455 can include any combination of hardware and software for generating, assembling, creating and providing data packets of the multi-stream data 420. For example, packet assembler 455 can generate, assemble or create a data packet comprising one or more data packets from one or more streams 425. Packet assembler 455 can generate, assemble or create a data packet comprising the contents or payload of the one or more packets from one or more streams 425. Packet assembler 455 can generate, create or provide a QUIC packet for a QUIC communication protocol. Packet assembler 455 can generate, create or provide a multi-stream data 420 packet in accordance with the priority instructions 450 and on behalf of the MSS 430.

Once generated, packets can be stored, saved or placed in a packet queue 460. Packet queue 460 can include a buffer for storing packets generated by the packet assembler 455. Packet queue 460 can store any number of packets for the multi-stream data 420 (e.g., QUIC packets comprising data or contents of one or more packets from one or more streams 425). Packet queue 460 can provide stored packets for transmission via a wireless link 465. Packets can be stored and provided in any order, such as first-in-first-out (FIFO), or first-in-last-out (FILO), round robin or any other order.

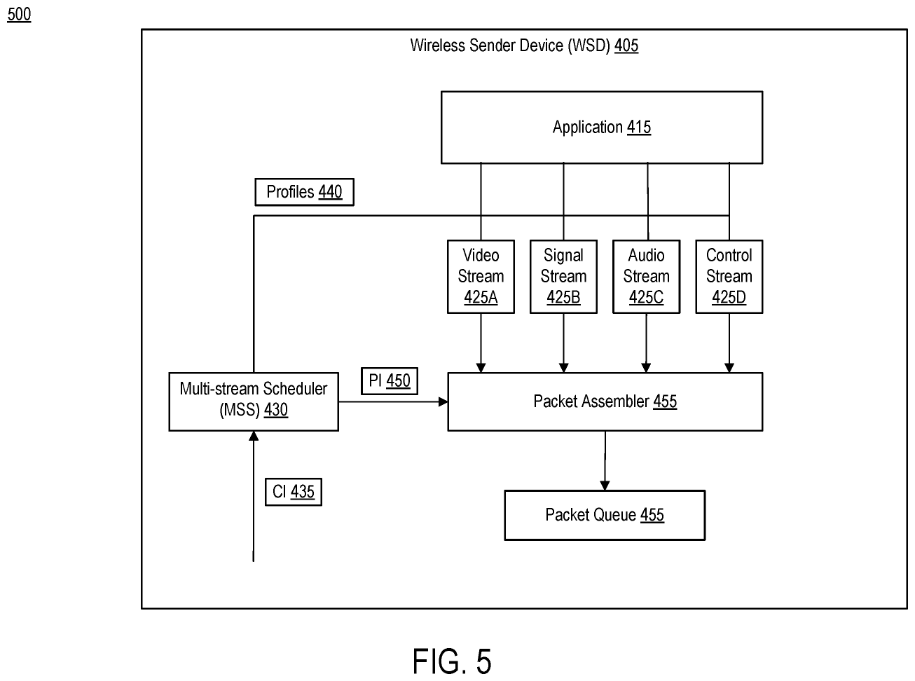

FIG. 5 illustrates an example 500 of a wireless sender device 405 implementing QoS for data packets of multiple streams 425 within a single protocol multi-stream data 420 cellular network transmission, in accordance with the present solution. WSD 405 of the example 500 can include any functionality of the WSD 405 described in system 400 or vice versa. A WSD 405 can include an application 415 that generates multiple data streams 425. Streams 425 can include a video stream 425A, a signal stream 425B, an audio stream 425C and/or a control stream 425D. Data packets of each of the video streams 425A-D can be received or accessed by the packet assembler 450. A multi-stream scheduler 430 can receive one or more congestion information 435 (e.g., from a remote WRD 470) and one or more profiles 440 for each of the streams 425A-D from the application 415. MSS 430 can utilize the congestion information 435 and the profiles 440 to generate (e.g., via a priority function 445 in the MSS 430) one or more priority instructions 450 for the packet assembler 455. Packet assembler 455 can utilize the received priority instructions 450 to generate data packets for the single protocol multi-stream data 420 in accordance with the priority instructions 450. Data packets generated by the packet assembler 455 can include any ratio of data packets from any streams 425A-D based on the congestion information 435 for any of the streams 425A-D and any profiles 440 for any of the streams 425A-D. Packet assembler 455 can therefore generate data packets of the multi-stream data 420 (e.g., QUIC multi-stream) to include increased or decreased amounts or ratios of data packets from any given stream 425A-D to maintain latency or bandwidth of each of the streams 425A-D within their predetermined or preferred latency range or bandwidth range.

For example, example 500 can include a cloud-based VR application 415 that generates 4 streams 425 (e.g., a video stream 425A, a signaling stream 425B, an audio stream 425C and a control stream 425D). QoS profiles 440 for each of the four streams 425A-D can be sent to multi-stream scheduler 430 by the application 415. Using the profiles 440, the MSS 430 can recognize the data rate, time budget requirements and/or packet size information for each stream 425A-D. MSS 430 can also determine the bandwidth and experienced latency for each stream 425A-D from the congestion information 435 received from the WRD 470. MSS 430 can determine the number of packets that are going to be sent out, via a multi-stream data 420, from each individual stream 425A-D, according to the profile 440 and CI 435 information or data. For example, the MSS 430 and the packet assembler 455 can maintain or satisfy the minimum data rate for each stream 425A-D using algorithms, such as the leaky bucket algorithm. Retransmission packets from each of the streams 425A-D can be prioritized with higher priority depending on the respective QoS profile 440. For example, in response to determining that there remains more available bandwidth (e.g., detect additional bandwidth headroom), the average data rate for each stream 425A-D can be maintained using the priority function 445 issuing priority instructions 450 to increase the priority of the data packets from the streams 425 whose rate of transmission should increase. For example, if the estimated bandwidth cannot afford video packets delivery (e.g., stream 425A) the MSS 430 can drop one or more video packets belonging/corresponding to “P” or “B” video frames in the early stage to avoid potential lagging of other high priority streams. Packet assembler 455 can sort out all packets of the multi-stream data 420 according to the MSS 430 decisions in order of latency requirements for each packets.

In some aspects, the present solution relates to a wireless sender device 405 comprising at least one processor 316 configured to receive a plurality of profiles 440 corresponding to a plurality of streams 425A-D of data generated by an application 415 of the wireless sender device 405. The at least one processor 316 can be configured to receive, from a wireless receiver device 470 receiving the plurality of streams 425A-D of data (e.g., via a multi-stream data 420 comprising the streams 425A-D), congestion information 435 of at least some the plurality of streams 425 of data. The at least one processor 316 can be configured to determine, according to the congestion information 435 and the plurality of profiles 440, a priority (e.g., PI 450) of a first stream 425A of the plurality of streams 425A-D of data with respect to a second stream 425B of the plurality of streams 425A-D of data, for a single protocol stream (e.g., multi-stream data 420). The at least one processor 316 can be configured to generate a plurality of packets of the single protocol stream (e.g., 420) using first packets of the first stream 425A and second packets of the second stream 425B in accordance with the determined priority (e.g., PI 450). For example, the at least one processor 316 can be configured to combine one or more data packets of a first stream 425A, one or more data packets of a second stream 425B, one or more data packets of a third stream 425C and/or one or more data packets of a fourth stream 425D, in accordance with their individual latencies and bandwidth information (e.g., CI 435) and their individual profiles 440. The at least one processor 316 can be configured to transmit, to the wireless receiver device 370, the single protocol stream comprising the plurality of packets.

The at least one processor 316 can be configured to receive, from the wireless receiver device 470, the congestion information 435 indicative of a latency of the first stream 425A or the second stream 425B received via the single protocol stream (e.g., multi-stream data 420) at the wireless receiver device 470. The congestion information 435 can include information indicative of the latency of the data packets of any of the stream 425A and/or stream 425B. The at least one processor 316 can be configured to generate, according to the latency (e.g., determined according to the information indicative of the latency), the instruction to prioritize a packet of the first stream 425A over a packet of the second stream 425B.

The at least one processor 316 can be configured to receive, from the wireless receiver device 470, the congestion information 435 indicative of a bandwidth of the first stream 425A or the second stream 425B received via the single protocol stream (e.g., multi-stream data 420) at the wireless receiver device 470. For example, the CI 435 can include information on the current bandwidth corresponding to the stream 425A or 425B and/or any bandwidth headroom for the stream 425A or 425B. The at least one processor 316 can be configured to generate, according to the bandwidth (e.g., determined according to the information indicative of the bandwidth), the instruction to prioritize a packet of the first stream 425A over a packet of the second stream 425B. For example, the single protocol stream can include, for example, a quick user datagram protocol internet connections (QUIC) stream. For example, the packets from the streams 425A-D can be included within the data packets of the QUIC stream.

The at least one processor 316 can be configured to receive, from the application 415, a first profile 440A of the plurality of profiles 440 corresponding to the first stream 425A and a second profile 440B of the plurality of profiles 440 corresponding to the second stream 425B. The first profile 440A can indicate at least one of a first data rate, a first time budget, a first packet size, a first packet loss data or a first packet prioritization data of the first stream 425A. The second profile 440B can indicate at least one of a second data rate, a second time budget, a second packet size, a second packet loss data or a second packet prioritization data of the second stream 425B. The at least one processor 316 can be configured to generate the instruction to prioritize (e.g., PI 450) the first stream 425A over the second stream 425B according to the first profile 440A and the second profile 440B.

The at least one processor 316 can be configured to receive, from the multi-stream scheduler 430, the instruction (e.g., priority instruction 450). The at least one processor 316 can be configured to provide, to a packet queue 460 of the wireless sender device 405 according to the instruction (e.g., PI 450), the single protocol stream (e.g., multi-stream data 420) comprising the plurality of packets. For example, the at least one processor 316 can utilize the packet assembler 455 to assemble one or more packets of a single protocol multi-stream data 420 (e.g., QUIC stream) to include packets from one or more streams 425A in accordance with the priority instructions 450. The at least one processor 316 can be configured to determine, using the plurality of profiles 440, a first data rate and a first time budget for the first stream 425A and a second data rate and a second time budget for the second stream 425B. The at least one processor 316 can be configured to generate the instruction (e.g., PI 450) according to the first data rate, the first time budget, the second data rate and the second time budget.

The at least one processor 316 can be configured to determine, according to the congestion information 435, a codec rate for one of the first stream 425A or the second stream 425B. The at least one processor 316 can be configured to update, by the application of the wireless sender device, the codec rate for the first stream or the second stream. The at least one processor 316 can be configured to determine, according to the information on congestion, a supported rate of video frames of the first stream or the second stream. The at least one processor 316 can be configured to drop, by the application of the wireless sender device according to the supported rate of the video frames, a video frame of the first stream or the second stream.

In some aspects, the present solution is directed to a non-transitory computer readable medium storing program instructions. The instructions can be for causing at least one processor 316 of a device (e.g., WSD 405) to receive a plurality of profiles corresponding to a plurality of streams of data generated by an application of the wireless sender device. The instructions can be for causing at least one processor 316 of a device (e.g., WSD 405) to receive, from a wireless receiver device 470 receiving the plurality of streams 425 of data, congestion information 435 of at least some the plurality of streams 425 of data. The instructions can be for causing at least one processor 316 of a device (e.g., WSD 405) to determine, according to the congestion information 435 and the plurality of profiles 440, a priority of a first stream 425A of the plurality of streams 425 of data with respect to a second stream 425B of the plurality of streams 425 of data, for a single protocol stream (e.g., multi-stream data 420). The instructions can be for causing at least one processor 316 of a device (e.g., WSD 405) to generate a plurality of packets of the single protocol stream 425 using first packets of the first stream 425A and second packets of the second stream 425B in accordance with the determined priority. The instructions can be for causing at least one processor 316 of a device (e.g., WSD 405) to transmit, to the wireless receiver device 470, the single protocol stream (e.g., multi-stream data 420) comprising the plurality of packets.

The instructions can be for causing at least one processor 316 of a device (e.g., WSD 405) to receive, from the wireless receiver device 405, the congestion information 435 indicative of one of a latency of the first stream 425A or the second stream 425B or a bandwidth of the first stream 425A or the second stream 425B. The latency or the bandwidth can be received via the single protocol stream (e.g., multi-stream data 420) comprising a quick user datagram protocol internet connections (QUIC) stream at the wireless receiver device 470. The instructions can be for causing at least one processor 316 of a device (e.g., WSD 405) to generate, according to the latency or the bandwidth, the priority instruction 450 to prioritize a packet of the first stream 425A over a packet of the second stream 425B for the (QUIC) stream. For example, the instruction can cause the MSS 430 to include into a data packet of the single protocol stream a number of packets of the first stream 425A that is larger than a number of packets of the second stream 425B included in the same data packet, according to the priority instruction 450 indicating to prioritize the first stream 425A over the second stream 425B.

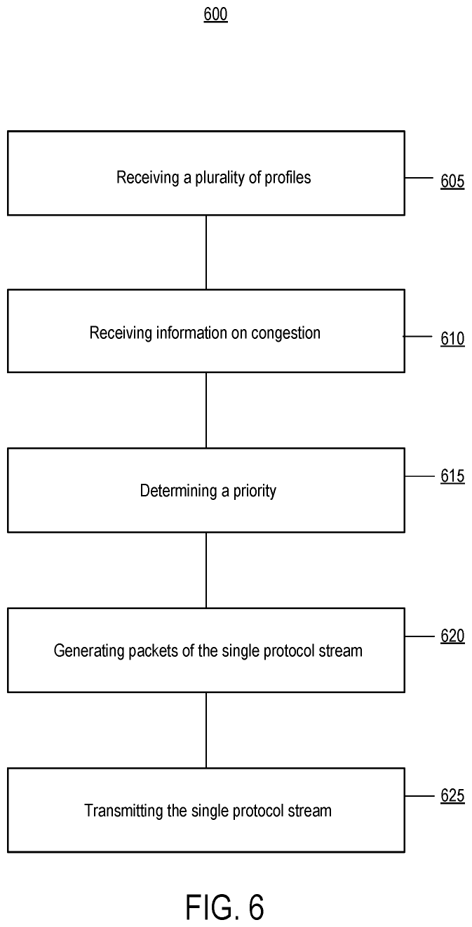

FIG. 6 illustrates an example flowchart of a method 600 of providing feedback based quality of service differentiation for/across multiple data streams transmitted via a single protocol multi-stream. Method 600 can be implemented by a system, such as the system 400, or embodiments described in connection with FIGS. 4-5. The method can include ACTS 605-625. At ACT 605, the method can including receiving a plurality of profiles. At ACT 610, the method can include receiving information on congestion. At ACT 615, the method can include determining a priority. At ACT 620, the method can include generating packets of the single protocol stream. At ACT 625, the method can include transmitting the single protocol stream.

At ACT 605, the method can include one or more processors of a wireless sender device receiving a plurality of profiles. The method can include a scheduler (e.g., a multi-stream scheduler) of the wireless sender device receiving a plurality of profiles corresponding to a plurality of streams of data generated by an application of the wireless sender device. For example, a multi-stream scheduler of a wireless sender device can receive a first profile for a first stream of a plurality of streams generated by the application and a second profile for a second stream of the plurality of streams.

The application can include any application operating on a wireless sender device (e.g., a UE), including a video or audio streaming application, a video conferencing application, a video game, an AR or VR application or any application that can generate one or more streams of data. Data streams generated by the application can include a video stream, an audio stream, a control stream, a signaling stream or any other data stream of any application executed on, or used by, a UE.

The scheduler can receive a first profile corresponding to a video stream of an application, a second profile corresponding to an audio stream of the application, a third profile for a signaling stream of the application and/or a fourth profile for a control stream of the application. Each of the streams can include a stream that can be combined/multiplexed/transmitted via QUIC multi-stream data session or connection over a wireless link. The profile can include a QoS profile for a QoS flow or configuration of a cellular network (e.g., 4G, 5G or 6G cellular network).

The scheduler can receive, from the application, a first profile of the plurality of profiles corresponding to the first stream and a second profile of the plurality of profiles corresponding to the second stream. The first profile can indicate at least one of a first data rate, a first time budget, a first packet size, a first packet loss data or a first packet prioritization data of the first stream. The second profile can indicate at least one of a second data rate, a second time budget, a second packet size, a second packet loss data or a second packet prioritization data of the second stream.

At ACT 610, the method can include one or more processors of a wireless sender device receiving information on congestion. The method can include the scheduler receiving, from a wireless receiver device receiving the plurality of streams of data, information on congestion of at least some the plurality of streams of data. For example, the scheduler can receive, from a wireless receiving device, via a wireless link, a congestion information on a plurality of streams of a multi-stream data (e.g., a QUIC stream including data packets of a plurality of streams generated by the application).

Congestion information can include latency information corresponding to a particular stream of a multi-stream data. Congestion information can include latency information corresponding to data packets of a particular stream. Congestion information can include bandwidth information corresponding to a particular stream of a multi-stream data, or to all streams. For example, congestion information can include bandwidth measurement or determination of a stream of data packets of a stream. Congestion information can include or correspond to any one or more of a bandwidth headroom, bandwidth maximum or minimum limitation or constraint or bandwidth target.

The multi-stream scheduler can receive, from the wireless receiver device, the information on congestion, which is indicative of a latency of the first stream or the second stream received via the single protocol stream at the wireless receiver device. The single protocol stream can include a QUIC stream comprising data from a plurality of streams generated by an application, such as a video stream, an audio stream, a control stream and/or a signaling stream.

The multi-stream scheduler can receive, from the wireless receiver device, the information on congestion, which is indicative of a bandwidth of the first stream or the second stream received via the single protocol stream at the wireless receiver device. For example, the scheduler can receive, from a wireless receiver device, a bandwidth measurement of a first stream and a bandwidth measurement of a second stream.

At ACT 615, the method can include one or more processors of a wireless sender device determining a priority. The method can include the scheduler determining, according to the information on congestion and the plurality of profiles, a priority of a first stream of the plurality of streams of data with respect to a second stream of the plurality of streams of data, for (e.g., for generating/forming/assembling) a single protocol stream. The priority function of the scheduler can determine the priority of the first stream and the second stream using, or according to, the congestion information of the first and the second streams and/or profiles of the first and the second streams.

The scheduler can generate, according to the latency, the instruction to prioritize a packet of the first stream over a packet of the second stream. The latency can include or be determined using latency information or data corresponding to the first stream or the second stream. The scheduler can generate, according to the bandwidth, the instruction to prioritize a packet of the first stream over a packet of the second stream. The bandwidth can include or be determined using bandwidth information or data corresponding to the first stream or the second stream.

The scheduler can generate, the instruction (e.g., priority instruction) to prioritize the first stream over the second stream according to the first profile and the second profile. The scheduler can determine, using the plurality of profiles, a first data rate and a first time budget for the first stream and a second data rate and a second time budget for the second stream. The scheduler can generate the instruction according to the first data rate, the first time budget, the second data rate and the second time budget.

The wireless sender device can determine, according to the information on congestion, a codec rate for one of the first stream or the second stream. The codec rate can include or correspond to the codec rate for a stream, such as a video stream, audio stream or an AR/VR stream. The wireless sender device can determine, according to the information on congestion, a supported rate of video frames of the first stream or the second stream. For example, the wireless sender device can determine a rate of video frames that can be supported within the boundaries of the bandwidth available (e.g., bandwidth headroom). Responsive to the determined rate of video frames, the wireless sender device can set the rate of video frames for the video stream.

At ACT 620, the method can include one or more processors of a wireless sender device generating packets of the single protocol stream. The method can include an assembler (e.g., a packet assembler) of the wireless sender device generating a plurality of packets of the single protocol stream using first packets of the first stream and second packets of the second stream in accordance with the determined priority. For example, a packet assembler can assemble data packets of the single protocol stream (e.g., multi-stream data) using priorities and/or ratios of the data packets or contents of data packets of each of the streams to be included in the data packets of the single protocol stream determined by the scheduler according to the congestion information and profiles of the streams.

The assembler can receive, from the scheduler, the instruction. The instruction can include a priority instruction according to which the data packets of the single protocol streams can be generated, constructed, provided or created. The assembler can provide, to a packet queue of the wireless sender device according to the instruction, the single protocol stream comprising the plurality of packets. For example, the assembler can provide to the packet queue one or more data packets of the single protocol stream (e.g., a QUIC stream comprising data packets of the plurality of streams generated by the application).

The application can update the codec rate for the first stream or the second stream. The codec rate can be updated according to a new or updated codec rate determined by the wireless sender device. The application can drop, according to the supported rate of the video frames, a video frame of the first stream or the second stream. For example, the application can drop one or more video frames or provide video stream for the single protocol stream (e.g., multi-stream) at a new (e.g., reduced or increased) rate of video frames.

At ACT 625, the method can include one or more processors of a wireless sender device transmitting the single protocol stream. The method can include the wireless sender device transmitting to the wireless receiver device, the single protocol stream comprising the plurality of packets. For example, the wireless sender device can send, via a wireless interface and over a wireless link, one or more data packets of the single protocol stream (e.g., multi-stream) to a wireless receiver device (e.g., a UE device, a base station of a cellular network or an application or function of a cellular network). For example, the wireless sender device can transmit the single protocol stream that includes a quick user datagram protocol internet connections (QUIC) stream. The QUIC stream can include the data from the plurality of streams generated by the application. Each data packet of the single protocol stream can include a same 5 IP tuple.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a scheduler of a wireless sender device, a plurality of profiles corresponding to a plurality of streams of data generated by an application of the wireless sender device;
receiving, by the scheduler from a wireless receiver device receiving the plurality of streams of data, information on congestion of at least some the plurality of streams of data;
determining, by the scheduler according to the information on congestion and the plurality of profiles, a priority of a first stream of the plurality of streams of data with respect to a second stream of the plurality of streams of data, for a single protocol stream;
generating, by an assembler of the wireless sender device, a plurality of packets of the single protocol stream using first packets of the first stream and second packets of the second stream in accordance with the determined priority; and
transmitting, by the wireless sender device to the wireless receiver device, the single protocol stream comprising the plurality of packets.

2. The method of claim 1, comprising:
receiving, by the scheduler from the wireless receiver device, the information on congestion, the information indicative of a latency of the first stream or the second stream received via the single protocol stream at the wireless receiver device; and
generating, by the scheduler according to the latency, the instruction to prioritize a packet of the first stream over a packet of the second stream.

3. The method of claim 1, comprising:
receiving, by the scheduler from the wireless receiver device, the information on congestion, the information indicative of a bandwidth of the first stream or the second stream received via the single protocol stream at the wireless receiver device; and
generating, by the scheduler according to the bandwidth, the instruction to prioritize a packet of the first stream over a packet of the second stream.

4. The method of claim 1, wherein transmitting the single protocol stream comprises transmitting, by the wireless sender device, a quick user datagram protocol internet connections (QUIC) stream.

5. The method of claim 1, comprising:
receiving, by the scheduler from the application, a first profile of the plurality of profiles corresponding to the first stream and a second profile of the plurality of profiles corresponding to the second stream, the first profile indicating at least one of a first data rate, a first time budget, a first packet size, a first packet loss data or a first packet prioritization data of the first stream, the second profile indicating at least one of a second data rate, a second time budget, a second packet size, a second packet loss data or a second packet prioritization data of the second stream; and
generating, by the scheduler, the instruction to prioritize the first stream over the second stream according to the first profile and the second profile.

6. The method of claim 1 comprising:
receiving, by the assembler from the scheduler, the instruction; and
providing, by the assembler to a packet queue of the wireless sender device according to the instruction, the single protocol stream comprising the plurality of packets.

7. The method of claim 1 comprising:
determining, by the scheduler using the plurality of profiles, a first data rate and a first time budget for the first stream and a second data rate and a second time budget for the second stream; and
generating, by the scheduler, the instruction according to the first data rate, the first time budget, the second data rate and the second time budget.

8. The method of claim 1 comprising:
determining, by the wireless sender device according to the information on congestion, a codec rate for one of the first stream or the second stream; and
updating, by the application, the codec rate for the first stream or the second stream.

9. The method of claim 1, comprising:
determining, by the wireless sender device according to the information on congestion, a supported rate of video frames of the first stream or the second stream; and
dropping, by the application according to the supported rate of the video frames, a video frame of the first stream or the second stream.

10. A wireless sender device comprising:
at least one processor configured to:
receive, via a transceiver, a plurality of profiles corresponding to a plurality of streams of data generated by an application of the wireless sender device;
receive, via the transceiver from a wireless receiver device receiving the plurality of streams of data, information on congestion of at least some the plurality of streams of data;
determine, according to the information on congestion and the plurality of profiles, a priority of a first stream of the plurality of streams of data with respect to a second stream of the plurality of streams of data, for a single protocol stream;
generate a plurality of packets of the single protocol stream using first packets of the first stream and second packets of the second stream in accordance with the determined priority; and
transmit, via the transceiver to the wireless receiver device, the single protocol stream comprising the plurality of packets.

11. The wireless sender device of claim 10, wherein the at least one processor is configured to:
receive, via the transceiver from the wireless receiver device, the information on congestion, the information indicative of a latency of the first stream or the second stream received via the single protocol stream at the wireless receiver device; and
generate, according to the latency, the instruction to prioritize a packet of the first stream over a packet of the second stream.

12. The wireless sender device of claim 10, wherein the at least one processor is configured to:
receive, via the transceiver from the wireless receiver device, the information on congestion, the information indicative of a bandwidth of the first stream or the second stream received via the single protocol stream at the wireless receiver device; and
generate, according to the bandwidth, the instruction to prioritize a packet of the first stream over a packet of the second stream.

13. The wireless sender device of claim 10, wherein the single protocol stream comprises a quick user datagram protocol internet connections (QUIC) stream.

14. The wireless sender device of claim 10, wherein the at least one processor is configured to:
receive, via the transceiver from the application, a first profile of the plurality of profiles corresponding to the first stream and a second profile of the plurality of profiles corresponding to the second stream, the first profile indicating at least one of a first data rate, a first time budget, a first packet size, a first packet loss data or a first packet prioritization data of the first stream, the second profile indicating at least one of a second data rate, a second time budget, a second packet size, a second packet loss data or a second packet prioritization data of the second stream; and
generate the instruction to prioritize the first stream over the second stream according to the first profile and the second profile.

15. The wireless sender device of claim 10, wherein the at least one processor is configured to:
receive, via the transceiver from the scheduler, the instruction; and
provide, to a packet queue of the wireless sender device according to the instruction, the single protocol stream comprising the plurality of packets.

16. The wireless sender device of claim 10, wherein the at least one processor is configured to:
determine, using the plurality of profiles, a first data rate and a first time budget for the first stream, and a second data rate and a second time budget for the second stream; and
generate the instruction according to the first data rate, the first time budget, the second data rate and the second time budget.

17. The wireless sender device of claim 10, wherein the at least one processor is configured to:
determine, according to the information on congestion, a codec rate for one of the first stream or the second stream; and
update, by the application of the wireless sender device, the codec rate for the first stream or the second stream.

18. The wireless sender device of claim 10, wherein the at least one processor is configured to:
determine, according to the information on congestion, a supported rate of video frames of the first stream or the second stream; and
drop, by the application of the wireless sender device according to the supported rate of the video frames, a video frame of the first stream or the second stream.

19. A non-transitory computer readable medium storing program instructions for causing at least one processor of a device to:
receive, via a transceiver, a plurality of profiles corresponding to a plurality of streams of data generated by an application of the wireless sender device;
receive, via the transceiver from a wireless receiver device receiving the plurality of streams of data, information on congestion of at least some the plurality of streams of data;
determine, according to the information on congestion and the plurality of profiles, a priority of a first stream of the plurality of streams of data with respect to a second stream of the plurality of streams of data, for a single protocol stream;
generate a plurality of packets of the single protocol stream using first packets of the first stream and second packets of the second stream in accordance with the determined priority; and
transmit, via the transceiver to the wireless receiver device, the single protocol stream comprising the plurality of packets.

20. The non-transitory computer readable medium of claim 19, wherein the program instructions cause the at least one processor to:
receive, via the transceiver from the wireless receiver device, the information on congestion, the information indicative of one of a latency of the first stream or the second stream or a bandwidth of the first stream or the second stream, the latency or the bandwidth received via the single protocol stream comprising a quick user datagram protocol internet connections (QUIC) stream at the wireless receiver device; and
generate, according to the latency or the bandwidth, the instruction to prioritize a packet of the first stream over a packet of the second stream for the (QUIC) stream.
